(19) United States
(12) Patent Application Publication
(10) Pub. No.: US 2026/0249920 A1
(43) Pub. Date: Aug. 27, 2026

(54) VEHICLE DOOR APERTURE ASSEMBLY

(71) Applicant: JAGUAR LAND ROVER LIMITED, Whitley, Coventry, Warwickshire (GB)

(72) Inventor: Brian LIDGARD, Whitley, Coventry, Warwickshire (GB)

(21) Appl. No.: 19/163,742

(22) PCT Filed: Jan. 26, 2024
(86) PCT No.: PCT/EP2024/051947

§ 371 Date: Sep. 9, 2025

(30) Foreign Application Priority Data
Mar. 10, 2023 (GB) 2303555.3

(51) Int. Cl. B62D 25/02; B60J 10/84; B62D 27/02

(52) U.S. Cl. CPC B62D 25/02; B60J 10/84; B62D 27/023

(57) ABSTRACT

A vehicle door aperture assembly includes a body side outer panel having a panel edge portion and an inner body panel having an outer edge. The panel edge portion forms a hemmed connection around the outer edge. The hemmed connection has a hemmed shape with a first bend having a first radius of curvature between an outer facing portion of the panel edge portion and an intermediate portion of the panel edge portion and a second bend having a second radius of curvature between the intermediate portion of the panel edge portion and an inner facing portion of the panel edge portion. The first radius of curvature is larger than the second radius of curvature, the outer facing portion transitions directly into the first bend, the inner facing portion transitions directly into the second bend, and the outer facing portion and the inner facing portion are in parallel planes.

### TECHNICAL FIELD

The present disclosure relates to a vehicle door aperture assembly. Aspects of the invention relate to a vehicle door aperture assembly, a vehicle, and a method of manufacturing a vehicle door aperture assembly.

### BACKGROUND

Currently there is minimum legal radius of curvature for vehicle door apertures at the edge of the vehicle body, where a person's head passes by when entering and exiting the vehicle by that doorway. A vehicle door aperture may have a hemmed edge at the edge of the vehicle body where the minimum legal radius of curvature is required.

It is a challenge to meet the minimum legal radius of curvature requirement and to also reduce the space occupied by the hemmed edge (which is desirable to increase the space available for a person's entry and exit to and from the vehicle). It is also a challenge to meet the minimum legal radius of curvature requirement and to also reduce the mass (and therefore cost) of the material used to manufacture the vehicle body having the hemmed edge (which is desirable to improve energy efficiency of vehicle use and to reduce the cost of materials in manufacture of the vehicle). The above challenges are especially pertinent when also aiming to improve the vehicle aerodynamics, ensure a good seal between the door and vehicle, and in frameless door systems whereby the top of the door glass meets a seal on the vehicle body when the door glass is fully closed (wound up) and the door is closed.

It is an aim of the present invention to address one or more of the disadvantages associated with the prior art.

### SUMMARY OF THE INVENTION

Aspects and embodiments of the invention provide a vehicle door aperture assembly, a vehicle, and a method of manufacturing a vehicle door aperture assembly as claimed in the appended claims In an aspect there is provided a vehicle door aperture assembly comprising a body side outer panel and an inner body panel, the body side outer panel forming a hemmed connection around the inner body panel; wherein the hemmed connection comprises a first bend having a first radius of curvature at an outward-facing portion of the body side outer panel and a second bend having a second radius of curvature at an edge of the hemmed connection; wherein the first radius of curvature is larger than the second radius of curvature.

In an aspect there is provided a vehicle door aperture assembly comprising a body side outer panel having a panel edge portion and an inner body panel comprising an outer edge, the panel edge portion of the body side outer panel forming a hemmed connection around the outer edge of the inner body panel; wherein the hemmed connection has a hemmed shape comprising: a first bend having a first radius of curvature between an outer facing portion of the panel edge portion and an intermediate portion of the panel edge portion, and a second bend having a second radius of curvature between the intermediate portion of the panel edge portion and an inner facing portion of the panel edge portion; wherein the first radius of curvature is larger than the second radius of curvature; and wherein the outer facing portion transitions directly into the first bend, the inner facing portion transitions directly into the second bend, and the outer facing portion and the inner facing portion are in parallel planes.

The hemmed connection has a larger radius of curvature at the first bend, which is the user-facing bend or transition in the body side outer panel for users entering the vehicle via the open door aperture. The smaller radius of curvature at the second bend is inboard of the first bend. The hemmed connection may be described as a reverse-compressed hem. By locating the sharper radius of curvature of the second bend on the inside of the hemmed joint, and the larger radius of curvature of the first bend on the user-entry-facing outside of the vehicle, the large radius can meet safety radii requirements by having an curvature which is large enough to be safe when a user's head is passing close by it to enter the vehicle. The two bends together form part of a hemmed edge which may be considered to be a flange which overall has a small cross section to reduce bulk, and also allow for low gauge (thickness) material to be used for the inner body panel and the body side outer panel, again reducing bulk. The cross section may be considered to be small compared with a different form of hem, for example a rope hem having a bulge at the hemmed edge to accommodate the legal minimum radius of curvature requirement.

Also, providing a hemmed edge of the body side outer panel allows for an aesthetically pleasing edge to be located in the visible outer surface of the vehicle. The hemmed edge may also provide a secure connection of the overhang portion to a seal carrier portion of the inner body panel, for example in arrangements where there is a hidden seal carrier (that is, from view from an observer looking at the vehicle exterior).

Furthermore, the larger radius of curvature on the outward portion of the body side outer panel allows for the body side outer panel to be painted/spray-painted without issues arising from paint gathering/dripping / pooling at a sharp radius of curvature bend, as the outwardly visible first bend is a shallower/gentler bend which permits painting using standard techniques, such as spray painting, to a high quality finish.

The body side outer panel may comprise a roof portion and an overhang portion, the overhang portion defining an overhang volume thereunder. The hemmed connection may define an outer edge of the overhang portion. The overhang volume may be configured to receive an elongate window seal at least partially within. An elongate window seal may be configured to be received within a seal carrier portion of the inner body panel. The vehicle door aperture assembly may comprise an elongate window seal. It will be appreciated that the labels “window seal” and “elongate window seal” may be substituted for the labels “door seal” and “elongate door seal” in a frameless door system because this element serves to form a seal between the closed door and the door aperture edge, in the region of the window portion of the door where that window portion meets the door aperture edge, whereby the top of the window meets the elongate seal on the vehicle body when the door glass is fully closed (wound up) and the door is closed.

The seal carrier portion of the inner body panel may be located in the overhang volume. The seal carrier rail thus may be located substantially out of sight of a user approaching passing or entering the vehicle and covered from exposure to environmental factors, inside the seal carrier and within the overhang volume edged by the hemmed connection.

The hemmed connection may comprise: a hemmed connection edge at a first side of the hemmed connection, and a hemmed connection body located between the hemmed connection edge and an inboard body side outer panel portion at a second side of the hemmed connection opposite the first side, wherein the second bend is located at the hemmed connection edge, and the first bend is located in the hemmed connection body in outer face portion.

The radius of curvature of the first bend may be at least 2.5 mm. The radius of curvature of the second bend may be at most 1.2 mm. A 2.5 mm radius of curvature may be a safety regulation requirement in some jurisdictions for a user-facing edge in the door aperture. In other jurisdictions a different lower radius of curvature limit may apply, and the radius of curvature of the first bend may be at least that different lower limit. A smaller radius of curvature may be formed at the second bend, with for example a 1.2 mm radius of curvature, to allow for a low-bulk hemmed connection to be made while still meeting the safety legislation.

The intermediate portion of the of the panel edge portion may be non-planar. For example it may convexly curve to form a continuous curved edge profile with the first and second bends. In other examples the intermediate portion may be at least partially planar.

The inner facing portion of the panel edge portion may extend planarly beyond the outer edge of the inner body panel between a portion of the inner facing portion adjacent to the outer edge and the second bend.

An outer surface of the outer edge may be separated from an inner surface of the outer face portion by an outer spacing gap configured to receive an adhesive to fix the outer edge to the outer face portion. An inner surface of the outer edge may be separated from an inner surface of the inner face portion by an inner spacing gap configured to receive an adhesive to fix the outer edge to the inner face portion. Thus adhesive may be located in the hemmed connection to connect the inner body panel to the body side outer panel to further increase the security of the fixing.

The outer spacing gap may have a perpendicular width of approximately 0.15 mm between the outer surface of the outer edge and the inner surface of the outer face portion. The inner spacing gap may have a perpendicular width of approximately 0.15 mm between the inner surface of the outer edge and the inner surface of the inner face portion.

The inner body panel may comprise an inner support panel, and a seal carrier located at the inner face. The seal carrier may comprise an outer seal carrier rail. The hemmed connection may comprise the body side outer panel edge portion hemmed over the outer seal carrier rail. The seal carrier may define an elongate recess volume configured to receive an elongate window seal therein.

The inner body panel may be formed of separate inner body panel elements, such as a seal carrier. The outer seal carrier rail may be joined to the body side outer panel by the hemmed connection to form an outer flange. The structure at the door aperture edge in such a vehicle door aperture assembly may provide for the seal carrier to be significantly hidden from view of a user passing the vehicle inside the body side outer panel of the vehicle. By joining the seal carrier at the outer rail side to the body side outer panel, a first outer flange is formed which is the visible portion of the door aperture and which acts to hide the majority of the window seal from view. Such an arrangement also acts to protect the seal from external environmental factors such as dust or adverse weather. Fixing the seal carrier to the body side outer panel provides a secure arrangement and an aesthetically pleasing window seal arrangement of the vehicle.

The seal carrier may further comprise an inner seal carrier rail parallel with the outer seal carrier rail, and the inner seal carrier rail may be joined to the inner support panel, to form an inner flange. The inner flange may form an inner door aperture edge. Fixing the seal carrier at the inner rail side to the body side inner panel to form a second inner flange also provides structural support to the vehicle, whereby the seal carrier contributes to the structural rigidity of the vehicle, and is itself securely fitted in the vehicle body.

The seal carrier may comprise an inset seal carrier rail joined between the outer seal carrier rail and the inner seal carrier rail. The outer seal carrier rail, inset seal carrier rail and inner seal carrier rail together may define an elongate recess volume. The inset seal carrier rail may be configured to support an elongate window seal received in the elongate recess volume.

A window seal can be joined to the seal carrier on the inset portion of the seal carrier while the inner and outer seal carrier rails to either side of the inset portion are joined to the body side outer panel and body side inner panels respectively. This arrangement facilitates manufacture while maintain good structural rigidity of the door panel seal assembly.

The inner seal carrier rail may extend at least partially below the outer body side edge. It is desirable to maximise the size of the door opening to allow for user entry to and exit from the vehicle, and while the inner edge may extend below the overhang edge, the extent of extension below the overhanging edge may desirably be minimised in order to maximise the size of the door opening, for example by arranging the seal carrier to be located substantially under the overhang portion. The term “below” should be understood in the reference frame of a vehicle in a normal state of use, of having all wheels contacting horizontal ground.

The seal carrier may comprise a first L-cross sectional portion and a second L-cross sectional portion. The first L-cross sectional portion may comprise a first inset portion and the outer seal carrier rail. The second L-cross sectional portion may comprise a second inset portion and the inner seal carrier rail. The first L-cross sectional portion and the second L-cross sectional portion may be arranged by overlapping and joining the first inset portion of the first L-cross sectional portion with the second inset portion of the second L-cross sectional portion to form the inset seal carrier rail of the seal carrier. The first inset portion of the first L-cross sectional portion may be located between the outer body side edge and the second inset portion of the second L-cross sectional portion. By providing two L-cross sectional portions and affixing them together to form the elongate recess volume, the assembly may be manufactured without requiring specialist equipment or adaptation of currently used manufacturing equipment.

The first inset portion of the first L-cross sectional portion forming part of the inset seal carrier rail may be located between the second inset portion of the second L-cross sectional portion and the elongate recess volume. The elongate recess volume may comprise an elongate window seal receiving surface opposite the second inset portion of the second L-cross sectional portion, the elongate recess volume configured to couple to an elongate window seal located in the elongate recess volume. If, despite the seal, water did pass over the seal inside the overhang portion then it would run over the back of the seal and exit the seal carrier at the external side of the vehicle. Furthermore if water did pass over the seal and the first L-cross sectional portion, it would pass between the inset portions of the 1st and 2nd L-cross sectional portions and again exit the seal carrier at the external side of the vehicle.

The outer seal carrier rail and inset seal carrier rail may be connected at a bend having an acute angle between the outer seal carrier rail and inset seal carrier rail in the elongate recess volume. By having an acute angle between the outer and inset seal carrier rails the seal carrier may be located inside the overhang volume in a way which increases the amount of the seal carrier which can be fitted inside the overhang volume. In some examples the outer seal carrier rail may be entirely located within the overhang volume, and the majority, if not all, of the inset seal carrier rail may be also located inside the overhang volume. Moreover, it is desirable to minimise the vertical separation between the outer hemmed edge formed by the overhang portion and the inner hemmed edge formed by the inner seal carrier rail of the seal carrier, to improve the vehicle aesthetic and to maximise the size of the space provided by the vehicle door to allow for user entry and exit to and from the vehicle. by providing an acute angle between the outer and inset seal carrier rails, this vertical separation is made smaller compared to a large angle between the outer and inset seal carrier rails being present.

The inner seal carrier rail and inset seal carrier rail may be connected at a bend having an obtuse angle between the inner seal carrier rail and inset seal carrier rail in the elongate recess volume. The outer and inner seal carrier rails may be arranged substantially in parallel planes by having an acute angle between the outer and inset seal carrier rails and an obtuse angle between the inner and inset seal carrier rails to allow for the space in the channel to receive the seal carrier member and seal, as well as the door glass when the window is wound up and the door glass is in contact with the seal. The acute angle and obtuse angle may sum to substantially 180 degrees in some examples.

The vehicle door aperture assembly may comprise a seal mount located in the elongate recess volume. The seal mount may be configured to receive an attachment portion of an elongate window seal and thereby join the elongate window seal to the seal mount. The seal may be joined to the inset seal carrier rail. The seal mount may be joined to the inset seal carrier rail of the seal carrier and located proximal to the outer seal carrier rail. The seal carrier rail may be located in the acute angle formed between the inset seal carrier rail and the outer seal carrier rail. At least a majority of the seal carrier rail may be located within the overhang portion in the overhang volume. The seal carrier rail may be located adjacent to the inset portion of the first L-cross sectional portion and may be joined by a fixing passing through both the inset portion of the first L-cross sectional portion and the inset portion of the second L-cross sectional portion. Thus the seal carrier rail may be located substantially out of sight of a user approaching passing or entering the vehicle, inside the seal carrier and within the overhang volume, and covered from exposure to environmental factors.

The body side outer panel may be configured to form a vehicle roof extending in a front-back direction from a windshield to a rear windshield of a vehicle. The hemmed connection may extend substantially along the length of the body side outer panel in the front-back direction. The hemmed connection may run along substantially the length of the vehicle roof from the front to the back (e.g. across the top of both side windows on a side of a vehicle having two sides doors per side), thus being readily machinable and providing a clean aesthetic.

The body side outer panel may be configured to form a vehicle roof extending in a side-side direction from a driver side to a passenger side of a vehicle. The hemmed connection may extend substantially along the width of the body side outer panel in the side-side direction. The hemmed connection can run along substantially the width of the vehicle across the top of the windshield and/or across the top of the rear windshield. Thus the roof panel can be manufactured with the claimed hemmed connection in a readily machinable way and providing a clean aesthetic.

In an aspect there is provided a method of manufacturing a vehicle door aperture assembly; the method comprising: providing a body side outer panel comprising a panel edge portion; providing an inner body panel comprising an outer edge; forming a hemmed connection by hemming the panel edge portion around the outer edge of the inner body panel to have a hemmed shape comprising: a first bend having a first radius of curvature between an outer facing portion of the panel edge portion and an intermediate portion of the panel edge portion, and a second bend having a second radius of curvature between the intermediate portion of the panel edge portion and an inner facing portion of the panel edge portion; wherein the first radius of curvature is larger than the second radius of curvature; and wherein the outer facing portion transitions directly into the first bend, the inner facing portion transitions directly into the second bend, and the outer facing portion and the inner facing portion are in parallel planes.

The method of manufacturing the vehicle door aperture assembly may comprise applying adhesive in an outer spacing gap between an outer surface of the outer edge and an inner surface of the outer face portion to fix the outer edge to the outer face portion. The method of manufacturing the vehicle door aperture assembly may comprise applying adhesive in an inner spacing gap between an inner surface of the outer edge and an inner surface of the inner face portion to fix the outer edge to the inner face portion.

In an aspect there is provided a vehicle chassis comprising any vehicle door aperture assembly as disclosed herein.

In an aspect there is provided a vehicle comprising any vehicle door aperture assembly disclosed herein, vehicle chassis disclosed herein, or manufactured according to any method disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle comprising a vehicle door aperture assembly according to examples disclosed herein;

FIG. 2A shows schematically a hemmed edge of the vehicle door aperture assembly of FIGS. 2C-2D according to examples disclosed herein;

FIG. 2B shows schematically a hemmed edge of the vehicle door aperture assembly of FIGS. 2C-2D according to examples disclosed herein;

FIG. 2C shows a schematic cross sectional view taken through a portion of the body (including the roof) of a vehicle showing a vehicle door aperture assembly according to examples disclosed herein.

FIG. 2D shows an alternative view of the vehicle door aperture assembly of FIG. 2C according to examples disclosed herein; and

FIG. 3 shows a method of manufacturing the vehicle door aperture assembly according to examples disclosed herein.

### DETAILED DESCRIPTION

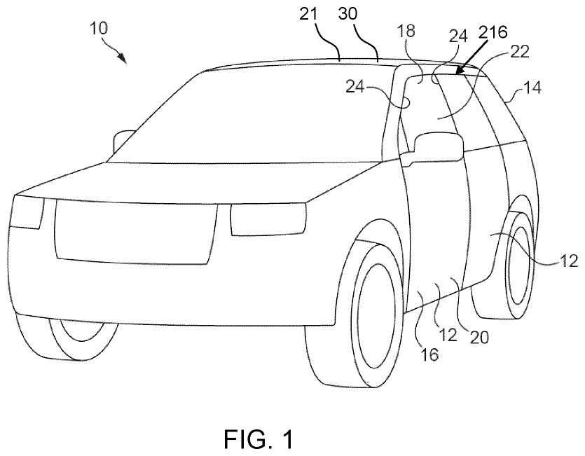

FIG. 1 shows a vehicle 10 comprising four side-doors 12 and one luggage compartment door 14. In other examples there may be different number of doors e.g. two doors. The description below is given in the context of the side-doors 12 but may also apply to the luggage compartment door 14 in some examples. Each side-door 12 comprises a lower portion 16 and an upper portion 18. The lower portion 16 comprises an outer door panel 20 which forms part of the exterior surface of the vehicle 10. The outer door panel 20 is attached to an internal structural frame (not shown in FIG. 1) which provides structural strength and rigidity to the door 12. The upper portion 18 of the door 12 comprises a moveable glass pane 22 which is supported, when in the closed position, by a window frame 24. The luggage compartment door 14 may comprise a fixed (non-moveable) glass pane. The roof portion 30 comprises an body side outer panel 21 which also forms part of the exterior surface of the vehicle 10. The body side outer panel 21 is also attached to an internal structural frame (not shown in FIG. 1) which provides structural strength and rigidity to the vehicle chassis.

The vehicle 10 comprises, as discussed in detail below, a vehicle window seal assembly 200 which itself comprises the body side outer panel 21, a body side inner panel (not shown), and a seal carrier (not shown) located between the body side outer panel and the body side inner panel. The seal carrier is configured to support a window seal for the moveable glass pane 22 to contact at the top of the moveable glass pane 22 / upper portion 18 of the side-door 12 when wound up/closed. In relation to a non-moveable glass pane such as a glass pane of the luggage compartment door 14, the seal carrier may be configured to support the window seal for the glass pane to contact at the top of the glass pane 22. The outer door aperture edge (also called an outer body side edge 216) is indicated as the boundary between the body side outer panel 21 and the moveable glass pane 22 (when the door 12 is closed and the moveable glass pane 22 is wound up), and also as the boundary between the body side outer panel 21 and the space through which a vehicle occupant may enter and exit the vehicle 10 (when the door 12 is open). A vehicle chassis (for example, a vehicle body comprising the side-doors 12 and luggage compartment door 14) may comprise a vehicle window seal assembly 200 as disclosed herein.

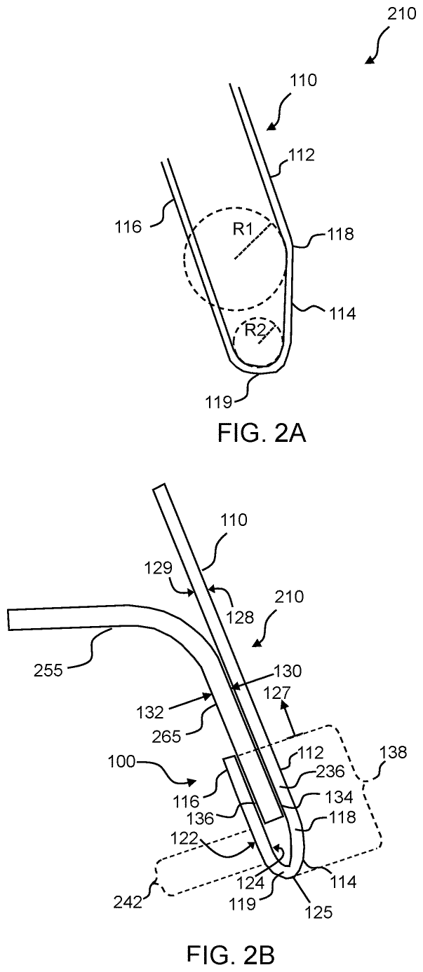

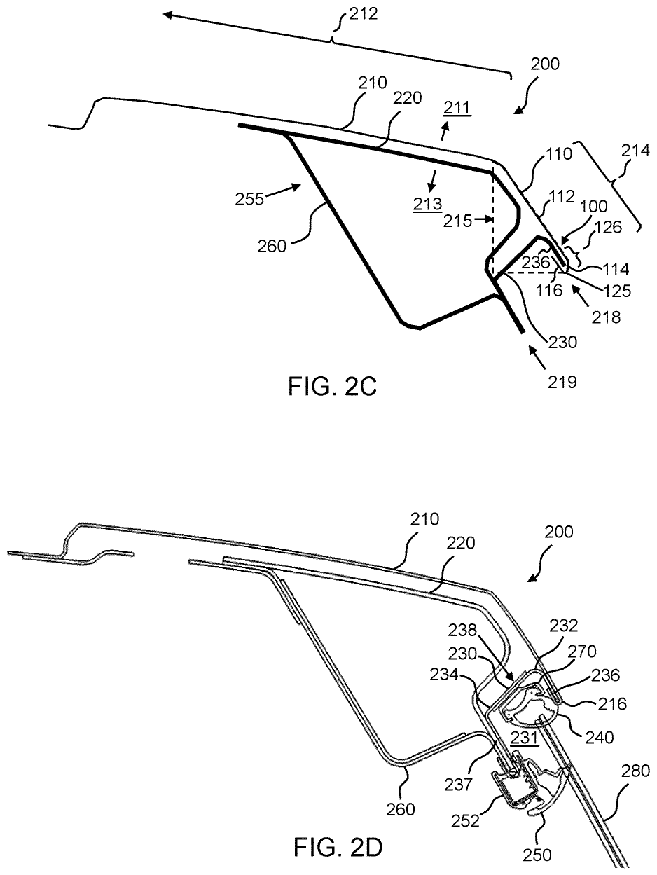

FIGS. 2A and 2B show schematically a hemmed edge of the vehicle door aperture assembly 200 of FIGS. 2C-2D. FIG. 2A shows the body side outer panel 210 forming a hemmed edge without the inner body panel 255. FIG. 2B shows the body side outer panel 210 forming a hemmed connection 100 with the inner body panel 255. The hemmed edge may be located at the outer body side edge 216 of a vehicle 10.

The hemmed edge is formed from a body side outer panel 210 of a vehicle. The body side outer panel 210 has a panel edge portion 110. The hemmed edge may be hemmed around an inner body panel 255 comprising an outer edge 265 as shown in FIG. 2B. The panel edge portion 110 of the body side outer panel 210 forms a hemmed connection 100 around the outer edge 265 of the inner body panel 255 as shown in FIG. 2B.

The hemmed connection 100 has a hemmed shape shown in FIG. 2A which comprising a first bend 118 having a first radius of curvature R1 between an outer face portion 112 of the panel edge portion 110 of the body side outer panel 210 and an intermediate portion 114 of the panel edge portion 110. The hemmed shape also comprises a second bend 119 having a second radius of curvature R2 between the intermediate portion 114 of the panel edge portion 110 and an inner facing portion 116 of the panel edge portion 110. The first radius of curvature R1 is larger than the second radius of curvature R2. The hemmed connection 100 may be said to comprise a hemmed connection edge 125 at a first side of the hemmed connection 100, and a hemmed connection body 138 located between the hemmed connection edge 125 and an inboard body side outer panel portion 127 at a second side of the hemmed connection 100 opposite the first side. The second bend 119 is located at the hemmed connection edge 125, and the first bend 118 is located in an outer face portion 112 of the hemmed connection body 138. When the hemmed edge is located at the outer body side edge 216 at the top of an open vehicle door aperture via which a user enters and exits the vehicle, the larger radius of curvature R1 at the first bend 118 is the user-facing bend or transition in the body side outer panel 210. The smaller radius of curvature R2 at the second bend 119 is inboard of the first bend 118.

A vehicle door aperture assembly 200 may be described as having a hemmed connection 100 as shown in FIGS. 2A-2B wherein the body side outer panel 210 forms a hemmed connection around the inner body panel 255; wherein the hemmed connection 100 comprises a first bend 118 having a first radius of curvature R1 at an outward-facing portion of the body side outer panel 210 and a second bend 119 having a second radius of curvature R2 at an edge of the hemmed connection 100; wherein the first radius of curvature R1 is larger than the second radius of curvature R2.

The hemmed connection 100 may be described as a “reverse-compressed” hem. By locating the sharper radius of curvature R2 of the second bend 119 on the inside of the hemmed connection 100, and the larger radius of curvature R1 of the first bend 118 on the user-entry-facing outside of the vehicle 10, the larger radius R1 can meet safety radii requirements by having an curvature which is large enough to be safe when a user is passing close by it to enter the vehicle. Also, providing a hemmed edge of the body side outer panel 210 allows for an aerodynamically efficient edge to be located in the visible outer surface of the vehicle 10. Furthermore, the larger radius of curvature R1 on the outward-facing portion of the body side outer panel 210 allows for the body side outer panel 210 to be painted/spray-painted while reducing problems which would arising from paint pooling or dripping from the painted first bend 118, since the painted first bend 118 does not have a sharp radius of curvature bend which would encourage paint pooling and dripping. The outwardly visible first bend 118 is a gentler bend and facilitates painting with an even thickness paint coat.

The outer face portion 112 transitions directly into the first bend 118. The inner facing portion 116 transitions directly into the second bend 119. The outer face portion 112 and the inner facing portion 116 are in parallel planes. The two bends 118, 119 together form part of a hemmed edge which may be considered to be a flange. This flange has a small cross section even though the first bend R1 has a larger radius of curvature (large enough to meet legal minimum requirements, for example) because the second bend 119 can have a small radius of curvature, therefore forming a flange overall which has low bulkiness compared to other hemmed edge profiles such as a rope hemmed edge. The hemmed connections 100 disclosed herein also allow for low gauge (thickness) material to be used for the inner body panel 255 and the body side outer panel 210 while providing a user-facing radius of curvature R1 of sufficient size, again desirably reducing the overall bulk of this portion of the vehicle.

The radius of curvature R1 of the first bend 118 may be at least 2.5 mm. The radius of curvature R2 of the second bend 119 may be at most 1.2 mm. A 2.5 mm radius of curvature may be a safety regulation requirement in some jurisdictions for a user-facing edge in the door aperture. In other jurisdictions a different lower radius of curvature limit may apply, and the radius of curvature R1 of the first bend 118 may be at least that different lower limit. A smaller radius of curvature R2 may be formed at the second bend 119, with for example a 1.2 mm radius of curvature, to allow for a low-bulk hemmed connection to be made while still meeting the safety legislation.

The intermediate portion 114 of the of the panel edge portion 110 may be at least partially planar in some examples, as shown in FIG. 2A where the intermediate portion has a straight cross-sectional shape between the first bend 118 and second bend 119. In other examples the intermediate portion 114 of the panel edge portion 110 may be non-planar. For example, as shown in FIG. 2B, it may convexly curve to form a continuous curved edge profile with the first bend 118 and the second bend 119. In other examples the intermediate portion 114 may have a different non-planar profile, such as a concave curve between the first bend 118 and the second bend 119.

FIGS. 2A and 2B shows schematically a hemmed edge of the vehicle door aperture assembly of FIGS. 2C-2D.

FIG. 2B shows that an outer face portion 112 has an outer surface 128 and an opposite inner surface 129. The inner face portion 116 also has an outer surface 122 and an opposite inner surface 124. The outer surfaces 128, 122 are so-called as they are on the outside of the hemmed connection 100 and the inner surfaces 124, 129 are so-called as they are on the inside of the hemmed connection 100. The two inner surfaces 124, 129 of the hemmed connection body 138 are adjacent to the respective outer surface 130 (i.e. from the point of view of the vehicle, an outer-facing surface 130) and inner surface 132 (i.e. from the point of view of the vehicle, an inner-facing surface 132) of the outer edge 265. The outer surface 130 of the outer edge 265 may be separated as shown from the inner surface 129 of the outer face portion 112 by an outer spacing gap 134 which is configured to receive an adhesive to fix the outer edge 265 to the outer face portion 112. An inner surface 132 of the outer edge 265 may be separated as shown from an inner surface 124 of the inner face portion 116 by an inner spacing gap 136 configured to receive an adhesive to fix the outer edge 265 to the inner face portion 116. Thus adhesive may be located in the hemmed connection 100 to connect the inner body panel 255 (the outer edge 265 thereof) to the body side outer panel 210, to further increase the security of the fixing. In other examples, other fixing mechanisms may be used to further secure the hemmed connection, for example, welding.

In some examples, the outer spacing gap 134 may have a perpendicular width of approximately 0.15 mm between the outer surface 130 of the outer edge 265 and the inner surface 129 of the outer face portion 112. In some examples, the inner spacing gap 136 may have a perpendicular width of approximately 0.15 mm between the inner surface 132 of the outer edge 265 and the inner surface 124 of the inner face portion 116. This size of spacing gap may provide for sufficient space for adhesive to be applied and strengthen the hemmed connection while allowing the hemmed connection to remain relatively low-bulk (compared for example to a rope hemmed connection).

FIG. 2B may be understood to show a portion of a vehicle door aperture assembly 200 comprising a body side outer panel 210 having a panel edge portion 110 and an inner body panel 255 comprising an outer edge 265. The panel edge portion 110 of the body side outer panel 210 forms a hemmed connection 100 around the outer edge 265 of the inner body panel 255. The hemmed connection 100 has a hemmed shape comprising a first bend 118 having a first radius of curvature R1 between an outer facing portion 112 of the panel edge portion 110 and an intermediate portion 114 of the panel edge portion 110, and a second bend 119 having a second radius of curvature R1 between the intermediate portion 114 of the panel edge portion 110 and an inner facing portion 116 of the panel edge portion 110. The first radius of curvature R1 is larger than the second radius of curvature R2. The outer facing portion 112 transitions directly into the first bend 118, the inner facing portion 116 transitions directly into the second bend 119, and the outer facing portion 112 and the inner facing portion 116 are in parallel planes. The inner facing portion 116 may extend planarly as shown in a planar extension region 242 beyond the outer edge 265 between a portion of the inner facing portion 116 adjacent to the outer edge 265 and the second bend 119.

The hemmed connection 100 may also provide a secure connection of the panel edge portion 110 of the body side outer panel 210 to a seal carrier portion 230 of the inner body panel 255, for example in arrangements where there is a hidden seal carrier (that is, located behind/inside the overhang portion 214). This is shown in more detail in FIGS. 2C and 2D. FIG. 2C shows a schematic cross sectional view taken through a portion of the body (including the roof) of a vehicle 10 showing a vehicle door aperture assembly 200. The hemmed edge of FIGS. 2A and 2B is present in the examples of FIGS. 2C and 2D.

FIGS. 2C and 2D show a cross sectional view taken through a portion of the body (including the roof) of a vehicle 10 showing a vehicle door aperture assembly 200. In this example the vehicle door aperture assembly 200 comprises a body side outer panel 210 forming the visible outer shell of the vehicle 10 (and may for example be painted with a bodywork colour paint). The vehicle door aperture assembly 200 also comprises an inner body panel 255. FIG. 2D also shows a moveable glass pane 280 which is fully wound up so the upper edge of the moveable glass pane 280 is in contact with an elongate window seal 240.

FIG. 2C shows that the body side outer panel 210 may comprise a roof portion 212 and an overhang portion 214. The overhang portion 214 defines an overhang volume 215 thereunder shows schematically as a space bounded by the overhang portion 214 and imaginary vertical and horizonal sides as illustrated. The hemmed connection 100 may be considered to define an outer edge of the overhang portion 214. “Vertical” may be understood to be perpendicularly upright with respect to the vehicle being located on horizontal ground with all wheels contacting the ground. Similarly “horizontal” may be understood to be parallel with the ground with respect to the vehicle being located on horizontal ground with all wheels contacting the ground. Thought of another way, the overhang volume 215 may be understood to be a space inboard of the body side outer panel 210 (i.e. in a direction towards the vehicle) underneath (i.e. covered by) the overhang portion 214 with the vehicle in a normal, all-wheels contacting horizontal ground, orientation).

The overhang volume 215 may be configured to receive an elongate window seal 240 at least partially within, as shown in FIG. 2D. In other words, an elongate window seal 240 may be configured to be received within a seal carrier portion 230 of the inner body panel 255. The vehicle door aperture assembly 100 may comprise an elongate window seal 240 in some examples. The seal carrier portion 230 of the inner body panel 255 may be located in the overhang volume 215 as shown. The seal carrier portion 230 thus may be located substantially out of sight of a user approaching passing or entering the vehicle, inside the seal carrier and within the overhang volume, and covered from exposure to environmental factors.

The inner body panel 255 may comprise an inner support panel and a seal carrier portion 230 located at the inner face 213. The inner face 213 of the inner body panel 255 faces inwardly towards the vehicle, opposite an outer face 211 of the inner body panel 255 facing the body side outer panel 210 and outwardly from the vehicle 10. The seal carrier portion 230 as shown has a squared-off U-shaped cross section but other cross-sectional shapes may be used. The inner support panel may in some examples be formed of separate inner body panel elements, such as a reinforcement panel 220, closer panel 260, and seal carrier 230 as shown in FIGS. 2C and 2D. The seal carrier portion 230 may comprise an outer seal carrier rail 236 (which is this example may be understood to be one side of the squared-off U-shaped cross section). The hemmed connection 100 may comprise the body side outer panel edge portion 110 hemmed over the outer seal carrier rail 236. The seal carrier portion 230 may define an elongate recess volume 231 configured to receive an elongate window seal 240 therein. The seal carrier portion 230 may comprise an inset seal carrier rail 238 joined between the outer seal carrier rail 236 and the inner seal carrier rail 237. The outer seal carrier rail 236, inset seal carrier rail 238 and inner seal carrier rail 237 together may be considered to define the elongate recess volume 231. The inset seal carrier rail 238 may be configured to support, as shown, an elongate window seal 240 received in the elongate recess volume 231.

By locating the seal carrier portion 230 adjacent to the hemmed connection 100 and fixing it to the body side outer panel 210, it is hidden from view of a user passing the vehicle and at least partially covered by the body side outer panel 210. Thus an elongate window seal 240 located in the seal carrier portion 230 is also shielded from external view and environmental factors. Fixing the seal carrier portion 230 to the body side outer panel 210 by the hemmed connection 100 also provides a secure arrangement and an aesthetically pleasing window seal arrangement of the vehicle 100.

The outer seal carrier rail 236 may be joined to the body side outer panel 210 by the hemmed connection 100 to form an outer flange 218. The seal carrier portion 230 may further comprise an inner seal carrier rail 237 parallel with the outer seal carrier rail 236, and the inner seal carrier rail 237 may be joined to the inner support panel, to form an inner flange 219. The inner flange 219 may form an inner door aperture edge. The structure at the door aperture edge in such a vehicle door aperture assembly may provide for the seal carrier portion 230 to be significantly hidden from view inside the body side outer panel of the vehicle. Furthermore, by joining the seal carrier portion 230 at the outer seal carrier rail 236 side to the body side outer panel 210, a first outer flange 218 is formed which is the visible portion of the door aperture and which acts to hide the majority of the window seal from view. Moreover, by joining the seal carrier portion 230 at the inner seal carrier rail 237 side to the inner body panel 255 to form a second inner flange 219, structural support is provided to the vehicle, the seal carrier portion 230 contributes to the structural rigidity of the vehicle 10, and is itself securely fitted in the vehicle body. Thus, the window seal 240 can be joined to the seal carrier portion 230 on the inset seal carrier rail 238 of the seal carrier portion 230 while the inner and outer seal carrier rails 236, 237 to either side of the inset seal carrier rail 238 are joined to the body side outer panel 210 and inner body panels 255 respectively. This arrangement facilitates manufacture while maintain good structural rigidity of the door aperture assembly 200.

The inner seal carrier rail 237 may extend at least partially below the outer body side edge 216. It is desirable to maximise the size of the door opening to allow for user entry to and exit from the vehicle, and while the inner edge at the end of the inner flange 219 may extend below the hemmed connection edge 125 and the end of the overhang porting 214, the extent of extension below the hemmed connection edge 125 may desirably be minimised in order to maximise the size of the door opening, for example by arranging the seal carrier portion 230 to be located substantially under the overhang portion 214 as shown.

As shown in FIG. 2D, the seal carrier portion 230 may comprise a first L-cross sectional portion 232 and a second L-cross sectional portion 234. Together these two portions 232, 234 are arranged together to form the squared-off U-shaped cross section of the seal carrier portion 230. The first L-cross sectional portion 232 may comprise a first inset portion and the outer seal carrier rail 236. The second L-cross sectional portion 234 may comprise a second inset portion and the inner seal carrier rail 237. The first L-cross sectional portion 232 and the second L-cross sectional portion 234 may be arranged by overlapping and joining the first inset portion of the first L-cross sectional portion 232 with the second inset portion of the second L-cross sectional portion 234 to form the inset seal carrier rail 238 of the seal carrier portion 230. The first inset portion of the first L-cross sectional portion 232 may be located between the outer body side edge 126 and the second inset portion of the second L-cross sectional portion 234.

By providing two L-cross sectional portions 232, 234 and affixing them together to form the seal carrier portion 230 having an elongate recess volume 231, the assembly 200 may be manufactured without requiring specialist equipment or adaptation of existing manufacturing equipment. This arrangement permits the fitting of the first L-cross sectional portion 232 to the body side outer panel 210 by the hemmed connection 100 because there is space for a hemming tool the make the hemmed connection 100 even though this first cross-sectional portion 232 is located substantially within the overhang volume 215 to be tucked out of external view of the completed vehicle 10. Once the first L-cross sectional portion 232 is affixed to the body side outer panel 210 by hemming as described in relation to FIGS. 2A and 2B, the second L-cross sectional portion 234 can be affixed to the first L-cross sectional portion 232 to form the complete seal carrier portion 230 joined to the body side outer panel 210. This assembly may then be joined to the inner body panel 255 as usual. The first inset portion of the first L-cross sectional portion 232 forming part of the inset seal carrier rail 238 may be located between the second inset portion of the second L-cross sectional portion 234 and the elongate recess volume 231. The elongate recess volume 231 may comprise an elongate window seal receiving surface opposite the second inset portion of the second L-cross sectional portion 234, and the elongate recess volume 231 is configured to couple to an elongate window seal 240 located in the elongate recess volume 231. Therefore if, despite the seal 240, water did pass over the seal inside the overhang portion 214 then it would run over the back of the seal 240 and exit the seal carrier portion 230 at the external side of the vehicle 10. Furthermore if water did pass over the seal 240 and the first L-cross sectional portion 232, it would pass between the inset portions of the first and second L-cross sectional portions 232, 234 and again exit the seal carrier portion 230 at the external side of the vehicle 10.

The outer seal carrier rail 236 and inset seal carrier rail 238 may be connected at a bend having an acute angle between the outer seal carrier rail 236 and inset seal carrier rail 238 in the elongate recess volume 231. By having an acute angle between the outer and inset seal carrier rails 236, 238 the seal carrier portion 230 may be located inside the overhang volume 215 in a way which increases the amount of the seal carrier portion 230 which can be fitted inside the overhang volume 215 compared with a larger angle between the outer seal carrier rail 236 and inset seal carrier rail 238. In some examples the outer seal carrier rail 236 may be entirely located within the overhang volume 215 and secured to the overhang portion 214 by the hemmed connection 100. The majority, if not all, of the inset seal carrier rail 238 may be also located inside the overhang volume 215. Moreover, it is desirable to minimise the vertical separation between the outer hemmed edge formed by the overhang portion 214 having the hemmed connection 100, and the inner edge 219 (which may also be a hemmed edge as shown in FIG. 2D) formed by the inner seal carrier rail 237 of the seal carrier portion 230, to improve the vehicle aesthetic and to maximise the size of the space provided by the vehicle door to allow for user entry and exit to and from the vehicle 10. By providing an acute angle between the outer and inset seal carrier rails 236, 238, this vertical separation is made smaller compared to a large angle between the outer and inset seal carrier rails 236, 238 being present.

The inner seal carrier rail 237 and inset seal carrier rail 238 may be connected at a bend having an obtuse angle between the inner seal carrier rail 237 and inset seal carrier rail 238 in the elongate recess volume 231. The outer and inner seal carrier rails 236, 238 may be arranged, as illustrated in FIGS. 2C and 2D, substantially in parallel planes by having an acute angle between the outer and inset seal carrier rails 236, 238 and an obtuse angle between the inner and inset seal carrier rails 237, 238 to allow for the space 231 in the channel to receive the seal carrier member 230 and seal 240, as well as the door glass 280 when the window is wound up and the door glass is in contact with the seal 240. The acute angle and obtuse angle may sum to substantially 180 degrees in some examples.

The vehicle door aperture assembly 200 may comprise a seal mount 270 located in the elongate recess volume 231. The seal mount 270 may be joined to the inset seal carrier rail 238. The seal mount 270 may be configured to receive an attachment portion of an elongate window seal 240 and thereby join the elongate window seal 240 to the seal mount 270. The seal mount 270 may be joined to the inset seal carrier rail 238 of the seal carrier portion 230 and located proximal to the outer seal carrier rail 236. The seal mount 270 may be located in the acute angle formed between the inset seal carrier rail 238 and the outer seal carrier rail 236. At least a majority of the seal carrier rail 230 may be located within the overhang volume 215. Thus the seal carrier rail 230 may be located substantially out of sight of a user approaching passing or entering the vehicle, being underneath the hemmed connection 100 forming the edge of the overhang portion 214, and inside the seal carrier portion 230 and within the overhang volume 231, and covered from exposure to environmental factors. The vehicle door aperture assembly 200 may further comprise in some examples, as shown in FIG. 2D, a second seal mount 252 joined to an inner edge (here, at the end of the inner flange 219) of the inner seal carrier rail 237. The second seal mount 252 is configured to have a second seal 250 joined thereto. The vehicle door aperture assembly 200 may further comprise the second seal 250 joined to the second seal mount 252 in some examples.

The body side outer panel 210 may be configured to form a vehicle roof extending in a front-back direction from a windshield to a rear windshield of a vehicle 10. The hemmed connection 100 may extend substantially along the length of the body side outer panel 210 in the front-back direction. The hemmed connection 100 may run along substantially the length of the vehicle roof from the front to the back (e.g. across the top of both side windows on a side of a vehicle having two sides doors per side), thus being readily machinable and providing a clean aesthetic. The body side outer panel 210 may be configured to form a vehicle roof extending in a side-side direction from a driver side to a passenger side of a vehicle 10. The hemmed connection 100 may extend substantially along the width of the body side outer panel in the side-side direction. The hemmed connection 100 can run along substantially the width of the vehicle 10 across the top of the windshield and/or across the top of the rear windshield. Thus the roof panel can be manufactured with the claimed hemmed connection 100 in a readily machinable way and providing a clean aesthetic.

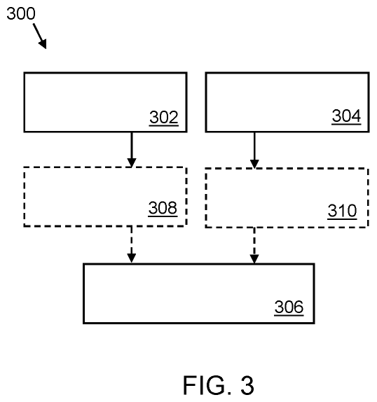

FIG. 3 illustrates a method 300 of manufacturing a vehicle door aperture assembly 200. The method 300 comprises providing 302 a body side outer panel 210 comprising a panel edge portion 110 and providing 304 an inner body panel 255 comprising an outer edge 265. The method 300 comprises forming 306 a hemmed connection 100 by hemming the panel edge portion 110 around the outer edge 265 of the inner body panel 255 to have a hemmed shape. The hemmed connection is formed 306 to have a hemmed shape comprising a first bend 118 having a first radius of curvature between an outer face portion 112 of the panel edge portion 110 and an intermediate portion 114 of the panel edge portion 110, and a second bend 119 having a second radius of curvature between the intermediate portion 114 of the panel edge portion 110 and an inner facing portion 116 of the panel edge portion 110. The hemmed connection is formed 306 so the first radius of curvature is larger than the second radius of curvature. The hemmed connection is formed 306 so the outer face portion 112 transitions directly into the first bend 118, the inner facing portion 116 transitions directly into the second bend 119, and the outer face portion 112 and the inner facing portion 116 are in parallel planes. The method 300 of manufacturing the vehicle door aperture assembly 200 may further comprise applying adhesive in an outer spacing gap 134 between an outer surface 130 of the outer edge 265 and an inner surface 129 of the outer face portion 112 to fix the outer edge 265 to the outer face portion 112, and/or applying adhesive in an inner spacing gap 136 between an inner surface 132 of the outer edge 265 and an inner surface 124 of the inner face portion 116 to fix the outer edge 265 to the inner face portion 112.

It will be appreciated that various changes and modifications can be made to the present invention without departing from the scope of the present application.

1. A vehicle door aperture assembly comprising a body side outer panel having a panel edge portion and an inner body panel comprising an outer edge, the panel edge portion of the body side outer panel forming a hemmed connection around the outer edge of the inner body panel;
wherein the hemmed connection has a hemmed shape comprising:
a first bend having a first radius of curvature between an outer facing portion of the panel edge portion and an intermediate portion of the panel edge portion, and
a second bend having a second radius of curvature between the intermediate portion of the panel edge portion and an inner facing portion of the panel edge portion;
wherein the first radius of curvature is larger than the second radius of curvature; and
wherein the outer facing portion transitions directly into the first bend, the inner facing portion transitions directly into the second bend, and the outer facing portion and the inner facing portion are in parallel planes.

2. The vehicle door aperture assembly of claim 1, wherein:
the body side outer panel comprises a roof portion and an overhang portion, the overhang portion defining an overhang volume thereunder;
the hemmed connection defined an outer edge of the overhang portion; and
the overhang volume is configured to receive an elongate window seal at least partially within.

3. The vehicle door aperture assembly of claim 1, wherein the hemmed connection comprises:
a hemmed connection edge at a first side of the hemmed connection, and
a hemmed connection body located between the hemmed connection edge and an inboard body side outer panel portion at a second side of the hemmed connection opposite the first side,
wherein the second bend is located at the hemmed connection edge, and the first bend is located in the hemmed connection body in outer face portion.

4. The vehicle door aperture assembly of claim 1, wherein one or more of:
the radius of curvature of the first bend is at least 2.5 mm; and
the radius of curvature of the second bend is at most 1.2 mm.

5. The vehicle door aperture assembly of claim 1, wherein the intermediate portion is non-planar.

6. The vehicle door aperture assembly of claim 1, wherein the inner facing portion extends planarly beyond the outer edge between a portion of the inner facing portion adjacent to the outer edge and the second bend.

7. The vehicle door aperture assembly of claim 1, wherein one or more of:
an outer surface of the outer edge is separated from an inner surface of the outer face portion by an outer spacing gap configured to receive an adhesive to fix the outer edge to the outer face portion; and
an inner surface of the outer edge is separated from an inner surface of the inner face portion by an inner spacing gap configured to receive an adhesive to fix the outer edge to the inner face portion.

8. The vehicle door aperture assembly of preceding claim 1, wherein:
the inner body panel comprises an inner support panel and a seal carrier located at the inner face,
the seal carrier comprises an outer seal carrier rail; and
the hemmed connection comprises the body side outer panel edge portion hemmed over the outer seal carrier rail.

9. The vehicle door aperture assembly of claim 8, wherein:
the outer seal carrier rail is joined to the body side outer panel by the hemmed connection to form an outer flange; and
the seal carrier further comprises an inner seal carrier rail parallel with the outer seal carrier rail, the inner seal carrier rail joined to the inner support panel to form an inner flange.

10. The vehicle door aperture assembly of claim 9, wherein:
the seal carrier comprises a inset seal carrier rail joined between the outer seal carrier rail and the inner seal carrier rail, the outer seal carrier rail, inset seal carrier rail and inner seal carrier rail together defining an elongate recess volume; and the inset seal carrier rail is configured to support an elongate window seal received in the elongate recess volume.

11. The vehicle door aperture assembly of claim 10, wherein:
the seal carrier comprises a first L-cross sectional portion and a second L-cross sectional portion;
the first L-cross sectional portion comprises a first inset portion and the outer seal carrier rail, and the second L-cross sectional portion comprises a second inset portion and the inner seal carrier rail; and
the first L-cross sectional portion and the second L-cross sectional portion are arranged by overlapping and joining the first inset portion of the first L-cross sectional portion with the second inset portion of the second L-cross sectional portion to form the inset seal carrier rail of the seal carrier.

12. The vehicle door aperture assembly of claim 1, further comprising a seal mount located in the elongate recess volume, the seal mount configured to receive an attachment portion of an elongate window seal and thereby join the elongate window seal to the seal mount.

13. The vehicle door aperture assembly of any preceding claim 1, wherein:
the body side outer panel is configured to form a vehicle roof extending in a front-back direction from a windshield to a rear windshield of a vehicle; and
the hemmed connection extends substantially along the length of the body side outer panel in the front-back direction.

14. A method of manufacturing a vehicle door aperture assembly; the method comprising:
providing a body side outer panel comprising a panel edge portion, providing an inner body panel comprising an outer edge; and
forming a hemmed connection by hemming the panel edge portion around the outer edge of the inner body panel to have a hemmed shape comprising:
first bend having a first radius of curvature between an outer facing portion of the panel edge portion and an intermediate portion of the panel edge portion, and
a second bend having a second radius of curvature between the intermediate portion of the panel edge portion and an inner facing portion of the panel edge portion;
wherein the first radius of curvature is larger than the second radius of curvature; and
wherein the outer facing portion transitions directly into the first bend, the inner facing portion transitions directly into the second bend, and the outer facing portion and the inner facing portion are in parallel planes.

15. A vehicle comprising the vehicle door aperture assembly of any claim 1.
